(19) United States
(12) Patent Application Publication
(10) Pub. No.: US 2026/0198555 A1
(43) Pub. Date: Jul. 16, 2026

(54) AEROSOL-GENERATING ARTICLE AND AEROSOL-GENERATING SYSTEM

(71) Applicant: KT&G CORPORATION, Daejeon (KR)

(72) Inventor: Tae Kyun KIM, Daejeon (KR)

(73) Assignee: KT&G CORPORATION, Daejeon (KR)

(21) Appl. No.: 19/137,812

(22) PCT Filed: Nov. 3, 2023
(86) PCT No.: PCT/KR2023/017497

§ 371 Date: Jun. 11, 2025

(30) Foreign Application Priority Data
Dec. 28, 2022 (KR) 10-2022-0186910

(51) Int. Cl. A24D 1/20; A24B 15/167; A24D 1/00; A24D 3/04; A24D 3/10; A24D 3/17; A24F 40/20; A24F 40/57; H05B 1/02; H05B 3/40

(52) U.S. Cl. CPC A24D 1/20; A24B 15/167; A24D 1/002; A24D 3/048; A24D 3/10; A24D 3/17; A24F 40/20; A24F 40/57; H05B 1/0252; H05B 3/40

(57) ABSTRACT

An aerosol-generating article is disclosed. An aerosol-generating article according to an embodiment comprises: a medium segment containing a tobacco medium; a first segment disposed upstream of the medium segment; and a second segment disposed downstream of the medium segment, wherein: the first segment contains a moisturizer; nicotine generated from the tobacco medium of the medium segment is transferred and adsorbed to at least one of the first segment and the second segment; in a first state where the temperature of the aerosol-generating article is a predetermined temperature or lower, nicotine may be transmitted through the medium segment or the second segment; and in a second state where the temperature of the aerosol-generating article reaches the predetermined temperature, nicotine may be transmitted from the first segment. Various other embodiments may be possible.

### TECHNICAL FIELD

The following embodiments relate to an aerosol-generating article and an aerosol-generating system.

### BACKGROUND ART

Recently, the demand for articles that may replace conventional cigarettes is increasing. For example, the demand for devices that generate aerosol by electrically heating a cigarette stick (e.g., cigarette-type electronic cigarettes) is increasing. Accordingly, research is being conducted on electrically heated aerosol-generating devices and cigarette sticks (or aerosol-generating articles) applied thereto.

For example, Patent Application Publication No. 10-2017-0132823 discloses a non-combustible flavor inhaler, a flavor source unit, and an atomization unit.

The above description has been possessed or acquired by the inventor(s) in the course of conceiving the present disclosure and is not necessarily an art publicly known before the present application is filed.

### DISCLOSURE OF THE INVENTION

### Technical Goals

A goal according to an embodiment is to provide an aerosol-generating system that does not require a preheating time.

A goal according to an embodiment is to provide an aerosol-generating article that enhances taste by transferring aerosol even at a low temperature.

A goal according to an embodiment is to provide an aerosol-generating article that generates free nicotine at low temperatures and nicotine salt at high temperatures.

### Technical Solutions

An aerosol-generating article according to an embodiment includes a medium segment including a tobacco medium, a first segment disposed upstream of the medium segment, and a second segment disposed downstream of the medium segment, wherein, the first segment includes a moisturizer, nicotine generated from the tobacco medium of the medium segment is transferred and adsorbed to at least one of the first segment and the second segment, in a first state where a temperature of the aerosol-generating article is a predetermined temperature or lower, nicotine is transferred through the medium segment or the second segment, and in a second state where a temperature of the aerosol-generating article reaches the predetermined temperature, nicotine is transferred from the first segment.

In an embodiment, the medium segment may be pH treated so that a pH is in a range of 7.0 or more and 9.5 or less.

In an embodiment, the first segment may include a filter portion. and a hollow portion including a longitudinal hollow.

In an embodiment, the filter portion may further include an organic acid.

In an embodiment, the nicotine may be transferred from the medium segment to the first segment, the nicotine may be adsorbed by the moisturizer, and the nicotine adsorbed by the moisturizer may react with the organic acid to generate a nicotine salt in the first segment.

In an embodiment, the filter portion may include a paper material.

In an embodiment, the second segment may include a cellulose acetate filter.

In an embodiment, the second segment may include a fragrance material.

An aerosol-generating system according to an embodiment includes an aerosol-generating article, and an aerosol-generating device including a housing for accommodating the aerosol-generating article, a heater unit for heating the aerosol-generating article, a controller including at least one processor, and a vaporizer for heating an aerosol-forming material to generate an aerosol and emitting the aerosol toward the aerosol-generating article, wherein the aerosol-generating article includes a medium segment including a pH-treated tobacco medium, a first segment disposed upstream of the medium segment and including an organic acid, and a second segment disposed downstream of the medium segment, and wherein a nicotine generated from the tobacco medium of the medium segment may be transferred and adsorbed to at least one of the first segment and the second segment.

In an embodiment, the first segment may include a moisturizer.

In an embodiment, the heater unit may be disposed outside the first segment.

In an embodiment, the controller may include a first mode in which the aerosol transfers nicotine from the medium segment or the second segment, and a second mode in which the heater unit heats the first segment to a predetermined temperature, and the nicotine transferred to the first segment is reacted with the organic acid to form a nicotine salt, and the nicotine salt is atomized and transferred.

In an embodiment, the controller may further include a third mode in which the aerosol transfers nicotine from the medium segment or the second segment, and a nicotine salt is atomized and transferred from the first segment heated by the heater unit.

### Effects of the Invention

An aerosol-generating system according to an embodiment may generate an aerosol even when a high temperature is not reached.

An aerosol-generating article according to an embodiment may improve a user's satisfaction with the use of the article by not requiring a waiting time.

An aerosol-generating article according to an embodiment may transfer an aerosol even at a low temperature, thereby improving the durability of a device.

The effects of the aerosol-generating system and aerosol-generating article according to an embodiment are not limited to those mentioned above, and other effects not mentioned will be clearly understood by those skilled in the art from the description below.

### BRIEF DESCRIPTION OF DRAWINGS

FIG. 1 is a block diagram of an aerosol-generating device according to an embodiment.

FIG. 2 is a diagram schematically illustrating an aerosol-generating system according to an embodiment.

FIG. 3 is a diagram schematically illustrating an aerosol-generating article of FIG. 2.

FIG. 4A is a diagram illustrating a part of the aerosol-generating system according to FIG. 2 and an aerosol flow path in a first state.

FIG. 4B is a diagram illustrating a part of the aerosol-generating system according to FIG. 2 and an aerosol flow path in a second state.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood throughout the whole specification that, when one part “includes” or “comprises” one component, the part does not exclude other components but may further include other components, unless the context clearly dictates otherwise. Also, terms such as “unit,” “module,” etc., as used in the specification may refer to a part for processing at least one function or operation, which may be implemented as hardware, software, or a combination of hardware and software.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components regardless of drawing numbers and a repeated description related thereto will be omitted. In the description of embodiments, detailed description of well-known related structures or functions will be omitted when it is deemed that such description will cause ambiguous interpretation of the present disclosure.

Also, in the description of the components of the embodiments, terms such as first, second, A, B, (a), (b), and the like may be used. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

Components included in an embodiment and components having a common function are described using the same names in other embodiments. Unless otherwise mentioned, the descriptions of the embodiments may be applicable to the following embodiments and thus, duplicated descriptions will be omitted for conciseness.

In the following embodiments, the term “aerosol-generating article” may refer to an article that accommodates a medium, in which an aerosol passes through the article and the medium is transferred. A representative example of the aerosol-generating article may be a cigarette. However, the scope of the disclosure is not limited thereto.

In the following embodiments, the term “upstream” or “upstream direction” may refer to a direction away from an oral region of a user (smoker), and the term “downstream” or “downstream direction” may refer to a direction approaching the oral region of the user. The terms “upstream” and “downstream” may be used to describe relative positions of components of an aerosol-generating article.

In the following embodiments, the term “puff” refers to inhalation by a user, and the inhalation refers to a situation in which a user draws in an aerosol into his or her oral cavity, nasal cavity, or lungs through the mouth or nose.

In an embodiment, an aerosol-generating device may be a device that generates an aerosol by electrically heating a cigarette accommodated in an inner space.

The aerosol-generating device may include a heater. In an embodiment, the heater may be an electrically resistive heater. For example, the heater may include an electrically conductive track, and the heater may be heated as a current flows through the electrically conductive track.

The heater may include a tubular heating element, a plate-shaped heating element, a needle-shaped heating element, or a rod-shaped heating element, and may heat the inside or outside of the cigarette according to the shape of a heating element.

The cigarette may include a tobacco rod and a filter rod. The tobacco rod may be formed as a sheet or a strand, or may be formed of tobacco leaves finely cut from a tobacco sheet. In addition, the tobacco rod may be enveloped by a thermally conductive material. For example, the thermally conductive material may be metal foil such as aluminum foil. However, embodiments are not limited thereto.

The filter rod may be a cellulose acetate filter. The filter rod may include at least one segment. For example, the filter rod may include a first segment that cools an aerosol and a second segment that filters a predetermined ingredient contained in the aerosol.

In another embodiment, the aerosol-generating device may be a device that generates an aerosol using a vaporizer containing an aerosol generating material.

The aerosol-generating device may include a vaporizer containing the aerosol generating material and a main body supporting the vaporizer. The vaporizer may be detachably coupled to the main body. However, embodiments are not limited thereto. The vaporizer may be integrally formed or assembled with the main body, and may be secured to the main body so as not to be detached by a user. The vaporizer may be mounted on the main body while the aerosol generating material is accommodated therein. However, embodiments are not limited thereto. The aerosol generating material may be injected into the vaporizer while the vaporizer is coupled to the main body.

In another embodiment, the aerosol-generating device may generate an aerosol by heating the liquid composition, and the generated aerosol may pass through the cigarette and be delivered to the user. That is, the aerosol generated from the liquid composition may travel along airflow paths of the aerosol-generating device, and the airflow paths may be configured to allow the aerosol to pass through the cigarette and be delivered to the user.

Hereinafter, embodiments of the disclosure will be described in detail with reference to the accompanying drawings such that one of ordinary skill in the art may easily practice the disclosure. The disclosure may be practiced in forms that are implementable in the aerosol-generating devices according to various embodiments described above or may be embodied and practiced in many different forms and is not limited to the embodiments described herein.

Hereinafter, embodiments of the disclosure will be described in detail with reference to the drawings.

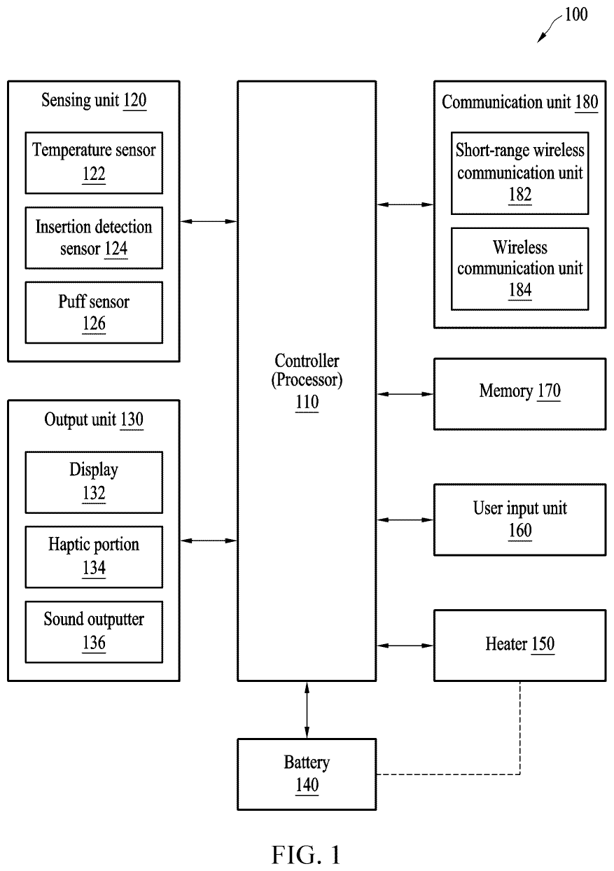

FIG. 1 is a block diagram of an aerosol-generating device according to an embodiment.

Referring to FIG. 1, an aerosol-generating device 100 may include a controller 110, a sensing unit 120, an output unit 130, a battery 140, a heater 150, a user input unit 160, a memory 170, and a communication unit 180. However, an internal structure of the aerosol-generating device 100 is not limited to what is shown in FIG. 1. It is to be understood by one of ordinary skill in the art to which the disclosure pertains that some of the components shown in FIG. 1 may be omitted or new components may be added according to the design of the aerosol-generating device 100.

The sensing unit 120 may sense a state of the aerosol-generating device 100 or a state of an environment around the aerosol-generating device 100, and transmit sensing information obtained through the sensing to the controller 110. Based on the sensing information, the controller 110 may control the aerosol-generating device 100 to control operations of the heater 150, restrict smoking, determine whether an aerosol-generating article (e.g., an aerosol-generating article, a vaporizer, etc.) is inserted, display a notification, and perform other functions.

The sensing unit 120 may include at least one of a temperature sensor 122, an insertion detection sensor 124, or a puff sensor 126. However, embodiments are not limited thereto.

The temperature sensor 122 may sense a temperature at which the heater 150 (or an aerosol generating material) is heated. The aerosol-generating device 100 may include a separate temperature sensor for sensing the temperature of the heater 150, or the heater 150 itself may also function as a temperature sensor. Alternatively, the temperature sensor 122 may be arranged around the battery 140 to monitor a temperature of the battery 140.

The insertion detection sensor 124 may sense whether the aerosol-generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol-generating article.

The puff sensor 126 may sense a puff from a user based on various physical changes in an airflow path or airflow channel. For example, the puff sensor 126 may sense the puff from the user based on one of a temperature change, a flow change, a voltage change, and a pressure change.

The sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 to 126 described above. A function of each sensor may be intuitively inferable from its name by one of ordinary skill in the art, and thus, a detailed description thereof will be omitted herein.

The output unit 130 may output information about the state of the aerosol-generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

The display 132 may visually provide information about the aerosol-generating device 100 to the user. The information about the aerosol-generating device 100 may include, for example, a charging/discharging state of the battery 140 of the aerosol-generating device 100, a preheating state of the heater 150, an insertion/removal state of the aerosol-generating article, a limited usage state (e.g., an abnormal article detected) of the aerosol-generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

The haptic portion 134 may provide information about the aerosol-generating device 100 to the user in a haptic way by converting an electrical signal into a mechanical stimulus or an electrical stimulus. The haptic portion 134 may include, for example, a motor, a piezoelectric element, or an electrical stimulation device.

The sound outputter 136 may provide information about the aerosol-generating device 100 to the user in an auditory way. For example, the sound outputter 136 may convert an electrical signal into a sound signal and externally output the sound signal.

The battery 140 may supply power to be used to operate the aerosol-generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol-generating device 100. The battery 140 may be a rechargeable battery or a disposable battery. The battery 140 may be, for example, a lithium polymer (LiPoly) battery. However, embodiments are not limited thereto.

The heater 150 may receive power from the battery 140 to heat the aerosol generating material. Although not shown in FIG. 1, the aerosol-generating device 100 may further include a power conversion circuit (e.g., a direct current (DC)-to-DC (DC/DC) converter) that converts power of the battery 140 and supplies the power to the heater 150. In addition, when the aerosol-generating device 100 generates an aerosol by induction heating, the aerosol-generating device 100 may further include a DC-to-alternating current (AC) (DC/AC) converter that converts DC power of the battery 140 into AC power.

The controller 110, the sensing unit 120, the output unit 130, the user input unit 160, the memory 170, and the communication unit 180 may receive power from the battery 140 to perform functions. Although not shown in FIG. 1, the aerosol-generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like. However, embodiments are not limited thereto.

In another embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol-generating article and a second heater for heating a liquid.

The user input unit 160 may receive information input from the user or may output information to the user. For example, the user input unit 160 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol-generating device 100 may further include a connection interface such as a universal serial bus (USB) interface, and may be connected to another external device through the connection interface such as a USB interface to transmit and receive information or to charge the battery 140.

The memory 170, which is hardware for storing various pieces of data processed in the aerosol-generating device 100, may store data processed by the controller 110 and data to be processed by the controller 110. The memory 170 may include at least one type of storage medium of flash memory-type memory, hard disk-type memory, multimedia card micro-type memory, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, or an optical disk. The memory 170 may store an operating time of the aerosol-generating device 100, a maximum number of puffs, a current number of puffs, at least one temperature profile, data associated with a smoking pattern of the user, or the like.

The communication unit 180 may include at least one component for communicating with another electronic device. For example, the communication unit 180 may include a short-range wireless communication unit 182 and a wireless communication unit 184.

The short-range wireless communication unit 182 may include a Bluetooth communication unit, a Bluetooth low energy (BLE) communication unit, a near field communication unit, a wireless local area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 184 may include, for example, a cellular network communication unit, an Internet communication unit, a computer network (e.g., a LAN or wide-area network (WAN) communication unit, or the like. However, embodiments are not limited thereto. The wireless communication unit 184 may use subscriber information (e.g., international mobile subscriber identity (IMSI)) to identify and authenticate the aerosol-generating device 100 in a communication network.

The controller 110 may control the overall operation of the aerosol-generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that it may be implemented in other types of hardware.

The controller 110 may control the temperature of the heater 150 by controlling supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

The controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. In another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

The controller 110 may control the output unit 130 based on the sensing result obtained by the sensing unit 120. For example, when the number of puffs counted through the puff sensor 126 reaches a preset number, the controller 110 may inform the user that the aerosol-generating device 100 is to be ended soon, through at least one of the display 132, the haptic portion 134, or the sound outputter 136.

In an embodiment, the controller 110 may control a power supply time and/or a power supply amount for the heater 150 according to a state of the aerosol-generating article sensed by the sensing unit 120. For example, when the aerosol-generating article is in an over-humidified state, the controller 110 may control the power supply time for an inductive coil to increase a preheating time, compared to a case where the aerosol-generating article is in a general state.

An embodiment may be implemented in the form of a recording medium including instructions executable by a computer, such as a program module executable by the computer. A computer-readable medium may be any available medium that may be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

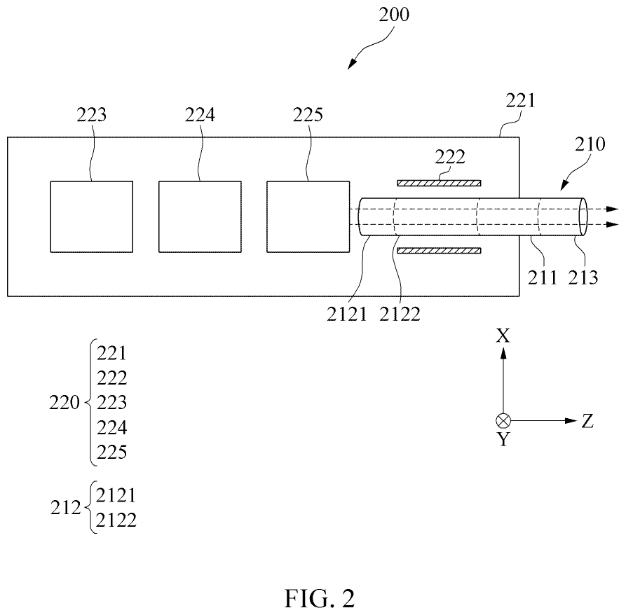

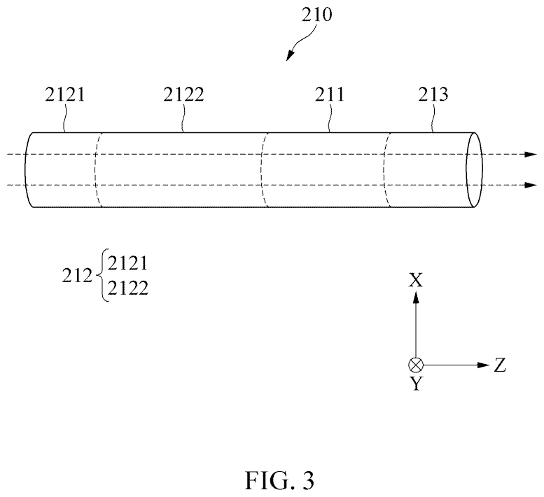

FIG. 2 is a diagram schematically illustrating an aerosol-generating system according to an embodiment, and FIG. 3 is a diagram schematically illustrating an aerosol-generating article of FIG. 2.

Referring to FIGS. 2 and 3, an aerosol-generating system 200 according to an embodiment may include an aerosol-generating article 210 and an aerosol-generating device 220 in which the aerosol-generating article 210 is accommodated.

In an embodiment, the aerosol-generating device 220 may generate an aerosol. For example, the aerosol-generating device 220 may generate an aerosol by heating an aerosol forming substrate stored in a vaporizer 225 and thereby aerosolizing it. However, this is only an example, and the aerosol-generating device 220 may aerosolize the aerosol forming substrate stored in the vaporizer 225 by using various principles, such as the principle of surface acoustic waves. In an embodiment, the aerosol-generating device 220 may include a housing 221, a heater unit 222, a battery 223, a controller 224, and the vaporizer 225.

In an embodiment, the housing 221 may be configured to accommodate various electronic/mechanical components. In an embodiment, the heater unit 222, the battery 223, the controller 224, the vaporizer 225, and at least a portion of the aerosol-generating article 210 described below may all be accommodated inside the housing 221 and safely protected from an external stimulus (e.g., dust, impact, heat, etc.).

In an embodiment, the battery 223 may be disposed in an internal space of the housing 221. In an embodiment, the battery 223 may supply power used to operate the aerosol-generating device 220. For example, the battery 223 may supply power to heat the heater unit 222 and/or the vaporizer 225 and may supply power required for the controller 224 to operate. In addition, the battery 223 may supply power required to operate a display, a sensor, a motor, or the like installed in the aerosol-generating device 200.

In an embodiment, the controller 224 may be disposed in the internal space of the housing 221. In an embodiment, the controller 224 may control the operation of the aerosol-generating device 220. In addition, the controller 224 may verify a status of each of the components of the aerosol-generating device 220 to determine whether the aerosol-generating device 220 is in an operable state.

In an embodiment, the controller 224 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that the processor may be implemented in other types of hardware.

In an embodiment, the vaporizer 225 may be disposed in the internal space of the housing 221. In an embodiment, the vaporizer 225 may store at least one aerosol forming substrate. For example, the aerosol forming substrate may include an aerosol generating material having any one of various states, such as a liquid state, a solid state, a gaseous state, and a gel state. The aerosol generating material may include a liquid composition. For example, the liquid composition may be a liquid including a tobacco-containing material having a volatile tobacco flavor component, or may be a liquid including a non-tobacco material. In an embodiment, the vaporizer 225 may be operated by an electrical signal or a wireless signal transmitted from the main body to perform the function of generating an aerosol by converting the phase of the aerosol generating material inside the vaporizer 225 to a gaseous phase. The aerosol may refer to a gas in which vaporized particles generated from the aerosol generating material are mixed with air. In an embodiment, the aerosol forming substrate stored in the vaporizer 225 may contain the same or different materials.

In an embodiment, the vaporizer 225 may store a functional material (not shown) that becomes an aerosol forming substrate. In an embodiment, the functional material may be stored inside the vaporizer 225 in at least one of a gaseous, liquid, or solid form. In an embodiment, the functional material may include a fragrance such as nicotine, glycerin, propylene glycol, menthol, a drug for the treatment of respiratory diseases such as asthma, chronic obstructive pulmonary disease, and the like, oil such as aromatic oil, caffeine, taurine, vaccines, and the like. The functional material is not limited to the examples described above and may include various materials. In an embodiment, the functional material stored in the vaporizer 225 may be the same or different materials.

In an embodiment, the vaporizer 225 may generate an aerosol by heating an aerosol forming substrate stored in the vaporizer 225. In an embodiment, the vaporizer 225 may emit an aerosol toward the aerosol-generating article 210. In an embodiment, the vaporizer 225 may include a heating element (not shown) for heating the aerosol forming substrate and a wick (not shown) for guiding the aerosol forming substrate to flow into the aerosol-generating article 210.

The heater unit 222 may be an electrically resistive heater. For example, the heater unit 222 may include an electrically conductive track, and the heater unit 222 may be heated up as a current flows through the electrically conductive track. However, the heater unit 222 is not limited to the above-described example, and any example of heating the heater unit 222 up to a predetermined temperature may be applicable without limitation. Here, the predetermined temperature may be preset in the aerosol-generating device 220 or may be set to a desired temperature by a user. In an embodiment, the heater unit 222 may be an induction heater. For example, the heater unit 222 may include an electrically conductive coil for heating a cigarette in an induction heating manner, and the aerosol-generating article 210 may include a susceptor (not shown) to be heated by the induction heater. For example, the heater unit 222 may include a tubular heating element, a plate-shaped heating element, a needle-shaped heating element, or a rod-shaped heating element, and may heat the inside or outside of the aerosol-generating article 210 according to the shape of a heating element.

In an embodiment, the heater unit 222 may be disposed in the internal space of the housing 221. For example, the heater unit 222 may be disposed in the internal space adjacent to at least a portion of the aerosol-generating article 210 accommodated in the housing 221. In an embodiment, the heater unit 222 may be heated by power supplied by the battery 223. In an embodiment, the heater unit 222 may heat the aerosol-generating article 210. For example, the heater unit 222 may heat the aerosol-generating article 210 when the aerosol-generating article 210 is inserted into the aerosol-generating device 220. In an embodiment, the heater unit 222 may control a temperature of the aerosol-generating article 210 by heating all or part of the aerosol-generating article 210. In an embodiment, the heater unit 222 may have a cylindrical or flat shape including a hollow, but is not limited thereto, and may have various shapes that may easily heat the aerosol-generating article 210.

In an embodiment, the aerosol-generating article 210 may be placed in the aerosol-generating device 220. In an embodiment, the aerosol-generating article 210 may provide a flow path that transfers an aerosol from the vaporizer 225 of the aerosol-generating device 220 to an oral region of a user. In an embodiment, the aerosol-generating article 210 may include a medium segment 211, a first segment 212, and a second segment 213.

In an embodiment, the medium segment 211 may include a cavity. In an embodiment, the cavity of the medium segment 211 may be filled with a medium. The medium filled in the cavity may include at least one of granular tobacco (tobacco granules), reconstituted tobacco, or tobacco charcoal.

In an embodiment, the medium segment 211 may include an aerosol generating material, such as glycerin or the like. In an embodiment, the medium segment 211 may contain other additives such as a flavoring agent, a humectant, and/or organic acid. In an embodiment, the medium segment 211 may be added with a flavoring agent such as menthol and/or a moisturizer from the first segment 212 and/or the second segment 213.

In an embodiment, the medium segment 211 may include a pH-treated tobacco medium. For example, the tobacco medium may be pH-treated by a pH control agent to have basicity (e.g., a pH concentration in a range of 7.0 to 9.5). The pH control agent may include at least one of potassium carbonate (K₂CO₃), sodium bicarbonate (NaHCO₃), and calcium oxide (CaO). However, the material included in the pH control agent is not limited to the above examples, and a material that generates less negative odor during smoking may be used. The basic pH control agent may increase the pH of the tobacco medium of the medium segment 211. The pH-treated tobacco medium may have an increased release of nicotine when heated. Accordingly, the pH-treated tobacco medium may achieve a sufficient nicotine yield even when the aerosol-generating article 210 is heated to a low temperature by the heater unit 222 of the aerosol-generating device 220.

In an embodiment, the medium segment 211 may include slurry or papermade reconstituted tobacco sheets having a pH adjusted to a range of 7.0 to 9.5, or may be filled with tobacco granules having a pH adjusted to a range of 7.0 to 9.5. The tobacco medium may include nicotine, and when the tobacco medium is pH-treated, free nicotine (e.g., nicotine gas) may be transferred from the tobacco medium even under non-heating conditions or relatively low temperature conditions. That is, by adjusting the pH of the tobacco medium in the medium segment 211 to a range of 7.0 to 9.5, volatile free nicotine may be transferred under non-heating conditions, and a sufficient level of intensity of smoking taste may be implemented. In an embodiment, free nicotine generated in the medium segment 211 may be transferred and adsorbed to at least one of the first segment 212 and the second segment 213.

In an embodiment, the first segment 212 may be disposed upstream of the medium segment 211. In an embodiment, the first segment 212 may include a filter portion 2121 including a filter material and a hollow portion 2122 having a hollow interior.

In an embodiment, the filter portion 2121 may include a paper material. The filter portion 2121 of a paper material may be heated by the heater unit 222 of the aerosol-generating device 220. In an embodiment, the filter portion 2121 may include a moisturizer. The moisturizer of the filter portion 2121 may contain free nicotine in the filter portion 2121 by adsorbing free nicotine transferred from the medium segment 211. In an embodiment, the filter portion 2121 may include an organic acid. The organic acid of the filter portion 2121 may react with the free nicotine adsorbed to the filter portion 2121 to generate a nicotine salt. In an embodiment, when the aerosol-generating article 210 is heated by the heater portion 222 of the aerosol-generating device 220, a nicotine salt may be transferred together with an aerosol generated from the vaporizer 225.

In an embodiment, the hollow portion 2122 may be formed with a hollow interior. The cavity formed in the hollow portion 2122 may be communicated with the vaporizer 225 of the aerosol-generating device 220. In an embodiment, the hollow portion 2122 may provide a flow path that allows the aerosol generated by the vaporizer 225 to flow into the medium segment 211.

In an embodiment, the second segment 213 may be disposed downstream of the medium segment 211. In an embodiment, the second segment 213 may include a cellulose acetate filter. In an embodiment, the second segment 213 may include a flavoring agent. The flavoring agent may be, for example, a capsule filled with menthol particles or a capsule filled with flavoring particles. The second segment 213 may be a cellulose acetate filter or a paper filter into which at least one flavor capsule is inserted.

In an embodiment, free nicotine may be transferred and adsorbed from the medium segment 211 to the second segment 213. Unlike nicotine salt that requires heating, free nicotine is a volatile substance, so the free nicotine adsorbed to the second segment 213 may be transferred together with the aerosol generated by the vaporizer 225 of the aerosol-generating device 220 even when the aerosol-generating article 210 is not heated. This may not only increase the convenience of the user, but also provide smoking taste satisfaction according to a sufficient transfer of nicotine even in an unheated state.

Below, a process of controlling the operation of the aerosol-generating system 200 through the controller 224 is described.

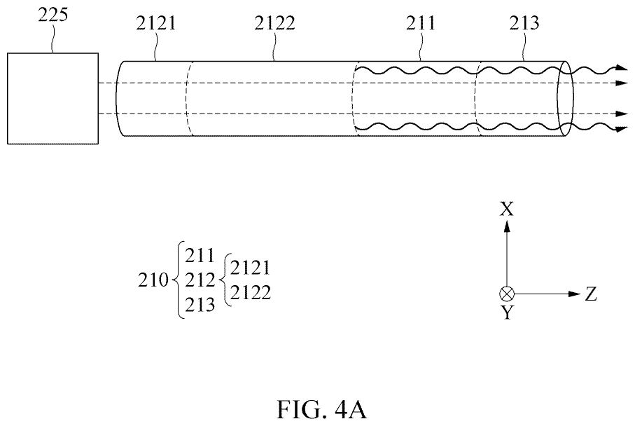

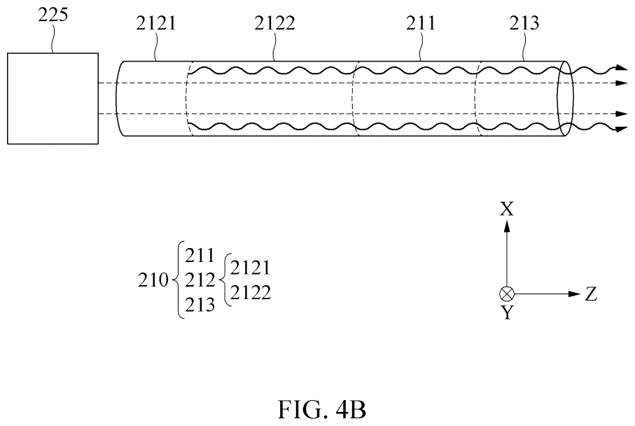

FIG. 4A is a diagram illustrating a part of the aerosol-generating system according to FIG. 2 and an aerosol flow path in a first state, and FIG. 4B is a diagram illustrating a part of the aerosol-generating system according to FIG. 2 and an aerosol flow path in a second state.

Referring to FIGS. 4A and 4B, a controller (e.g., the controller 224 of FIG. 2) according to an embodiment may control the operation of an aerosol-generating system (e.g., the aerosol-generating system 200 of FIG. 2). In an embodiment, the controller 224 may include at least one processor for controlling the operation of the aerosol-generating system 200. For example, the controller 224 may include a plurality of modes and may control the aerosol-generating system 200 to operate differently for each mode. In an embodiment, the controller 224 may include a first mode, a second mode, and a third mode, and may control an aerosol generated by the vaporizer 225 to be transferred to at least one of the first mode, the second mode, and the third mode.

In a first mode according to an embodiment, the controller 224 may control a heater unit (e.g., the heater unit 222 of FIG. 2) to heat an aerosol-generating article (e.g., the aerosol-generating article 210 of FIG. 2) to a predetermined temperature or lower. The predetermined temperature according to an embodiment may refer to a temperature at which a nicotine salt generated in the first segment 212 may be transferred together with the aerosol, for example, a temperature in a range of 150 degrees to 180 degrees. In a state where the aerosol-generating article 210 according to an embodiment is at a predetermined temperature or lower, free nicotine generated from the medium segment 211 and transferred and adsorbed to the second segment 213 may be transferred together with the aerosol.

In a second mode according to an embodiment, the controller 224 may control the heater unit 222 to heat the aerosol-generating article 210 to a predetermined temperature. When the aerosol-generating article 210 according to an embodiment reaches a predetermined temperature, the nicotine salt generated in the first segment 212 may be transferred together with the aerosol generated from the vaporizer 225.

In a third mode according to an embodiment, the controller 224 may continuously heat the heater unit 222 so that the temperature of the aerosol-generating article 210 reaches a predetermined temperature.

Referring to FIG. 4A, the controller 224 may control free nicotine to be transferred together with the aerosol as in the first mode in a first state where the temperature of the aerosol-generating article 210 is lower than or equal to the predetermined temperature.

Referring to FIG. 4B, the controller 224 may control the nicotine salt to be transferred together with the aerosol as in the second mode in the second state where the temperature of the aerosol-generating article 210 reaches the predetermined temperature.

The operating mechanism of the aerosol-generating system 200 by the controller 224 as described above may prevent or reduce the deterioration of the durability of the aerosol-generating device 220 and increase the user satisfaction by delivering free nicotine even when the aerosol-generating article 210 is not sufficiently heated.

While the embodiments have been described with reference to the limited drawings, it will be apparent to one of ordinary skill in the art that various alterations and modifications may be made from the above description. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and/or equivalents of the claims are within the scope of the following claims.

1. An aerosol-generating article, comprising:
a medium segment comprising a tobacco medium;
a first segment disposed upstream of the medium segment; and
a second segment disposed downstream of the medium segment,
wherein, the first segment comprises a moisturizer,
nicotine generated from the tobacco medium of the medium segment is transferred and adsorbed to at least one of the first segment and the second segment,
in a first state where a temperature of the aerosol-generating article is a predetermined temperature or lower, nicotine is transferred through the medium segment or the second segment; and
in a second state where a temperature of the aerosol-generating article reaches the predetermined temperature, nicotine is transferred from the first segment.

2. The aerosol-generating article of claim 1, wherein
the medium segment is pH treated so that a pH is in a range of 7.0 or more and 9.5 or less.

3. The aerosol-generating article of claim 1, wherein
the first segment comprises:
a filter portion; and
a hollow portion comprising a longitudinal hollow.

4. The aerosol-generating article of claim 3, wherein
the filter portion further comprises an organic acid.

5. The aerosol-generating article of claim 4, wherein
the nicotine is transferred from the medium segment to the first segment,
the nicotine is adsorbed by the moisturizer, and
the nicotine adsorbed by the moisturizer reacts with the organic acid to generate a nicotine salt in the first segment.

6. The aerosol-generating article of claim 3, wherein
the filter portion comprises a paper material.

7. The aerosol-generating article of claim 1, wherein
the second segment comprises a cellulose acetate filter.

8. The aerosol-generating article of claim 1, wherein
the second segment comprises a fragrance material.

9. An aerosol-generating system, comprising:
an aerosol-generating article; and
an aerosol-generating device comprising a housing for accommodating the aerosol-generating article, a heater unit for heating the aerosol-generating article, a controller comprising at least one processor, and a vaporizer for heating an aerosol-forming material to generate an aerosol and emitting the aerosol toward the aerosol-generating article,
wherein the aerosol-generating article comprises:
a medium segment comprising a pH-treated tobacco medium;
a first segment disposed upstream of the medium segment and comprising an organic acid; and
a second segment disposed downstream of the medium segment, and wherein a nicotine generated from the tobacco medium of the medium segment is transferred and adsorbed to at least one of the first segment and the second segment.

10. The aerosol-generating system of claim 9, wherein
the first segment comprises a moisturizer.

11. The aerosol-generating system of claim 9, wherein
the heater unit is disposed outside the first segment.

12. The aerosol-generating system of claim 11, wherein
the controller comprises:
a first mode in which the aerosol transfers nicotine from the medium segment or the second segment; and
a second mode in which the heater unit heats the first segment to a predetermined temperature, and the nicotine transferred to the first segment is reacted with the organic acid to form a nicotine salt, and the nicotine salt is atomized and transferred.

13. The aerosol-generating system of claim 12, wherein
the controller further comprises
a third mode in which the aerosol transfers nicotine from the medium segment or the second segment, and a nicotine salt is atomized and transferred from the first segment heated by the heater unit.
